(19) United States
(12) Patent Application Publication
(10) Pub. No.: US 2005/0048199 A1
(43) Pub. Date: Mar. 3, 2005

(54) Method for applying horizontal markings to roads or other traffic areas

(76) Inventors: Darrell L. Thompson, Pearl, MS (US); Zhonming Wang, Flowood, MS (US); Vincent R. Gurzo, Brandon, MS (US)

Correspondence Address: Richard J. Hammond, 5218 Riverbend Blvd., Baton Rouge, LA, 70820, US

(21) Appl. No.: 10/652,343

(22) Filed: Aug. 29, 2003

(51) Int. Cl. B05D 5/10

(52) U.S. Cl. 427/137

(57) ABSTRACT

The present invention is a method of applying horizontal markings to roads or other traffic areas, with the object being to lessen the curing time of the pavement-applied paint thereby allowing traffic onto the marked pavement in times that do not substantially impede traffic flow or contribute to traffic congestion. The method comprises applying to the road or other traffic area an aqueous, water-thinnable, acid-coagulable emulsion paint. Once the emulsion paint is contacted with the acid, it quickly cures. The acid that is used to speed the curing or drying of the emulsion paint is a dicarboxylic acid or a mixture of dicarboxylic acids.

### FIELD OF THE INVENTION

The present invention relates to an improved method for applying horizontal markings to various types of pavements using water-thinnable emulsion paints. More particularly, the present invention relates to an improved method for applying horizontal markings to roads or other traffic areas using water-thinnable emulsion paints that can be coagulated using an acid.

### BACKGROUND OF THE INVENTION

The present invention is particularly, but not exclusively, concerned with the formation of markings on pavements of various kinds. The most extensive use of such markings is to mark traffic lanes on roads and\or as indications of rights of way at intersections. Other examples of such markings are lines or other markings on paved aircraft runways and taxiways as well as lines indicating spaces in car parks. A further example is the use in traffic signs. Often, these markings include reflective elements, such as glass beads. Since any light that is incident to the markings that have such reflective elements is reflected toward the light source, marking compositions containing these reflective elements have very high night time visibility.

One of the most common type of pavement marking material are those that are solvent-based paints. While these materials have been used for many years, the presence of an organic, typically volatile solvent is environmentally disadvantageous. Latex paints, being water-based, are becoming more acceptable to the pavement marking industry since they do not have any organic solvents to vaporize into the atmosphere. However, they have long drying times which are a concern when considering the need to stop or divert traffic from roads that have been freshly marked with these materials or when rain may occur before curing (drying) is complete.

### SUMMARY

The present invention is a method of applying horizontal markings to roads or other traffic areas, with the object being to lessen the curing time of the pavement-applied paint thereby allowing traffic onto the marked pavement in times that do not substantially impede traffic flow or contribute to traffic congestion. The method comprises applying to the road or other traffic area an aqueous, water-thinnable, acid-coagulable emulsion paint. Once the emulsion paint is contacted with the acid, it quickly cures (otherwise termed “drying”). The acid that is used to speed the curing or drying of the emulsion paint is a polycarboxylic acid selected from the group consisting of a dicarboxylic acid, a tetracarboxylic acid and mixtures thereof.

### DESCRIPTION OF THE PREFERRED EMBODIMENTS

In the method of the present invention, it is preferred that a film of paint be applied to a pavement by using a moving vehicle equipped to spray or otherwise apply the paint film to the pavement surface. A spray head or nozzle is useful for applying the paint film.

In a typical configuration, a second spray head, nozzle or a particulate applicator is located rearwardly of the spray head that applies the paint. This second spray head is used to spray the polycarboxylic acid curing agent onto the fresh paint that was initially applied to the pavement surface. However, in one embodiment, the polycarboxylic acid is applied to the fresh paint by means of a coating on certain particulate matter, preferably glass beads. Hence, the use of a particulate scattering device rather than a spray head or nozzle.

It has been found advantageous to spray the polycarboxylic acid curing agent, or the coated particulate matter, directly into the paint as it sprays toward the pavement surface. Good mixing is assured in this manner, which results in a homogeneous cure of the paint after being applied to the pavement.

In the preferred embodiment of the present invention, a solution of the polycarboxylic acid curing agent is made with water as the solvent. The solution may be used “as is” by admixing with the paint spay as noted above. It may be also be used to coat particulate matter and, after drying, such coated particulate matter is then admixed with the paint spray as noted above.

The method of application of the polycarboxylic acid curing agent, either when use in aqueous solution or as a coating on particulate matter is described in EP-B-0 280 102 and in U.S. Pat. No. 5,544,972 both of which are incorporated herein by reference.

The method of the present invention can be achieved by using commercially available, water-thinnable, acid coagulable paint dispersions. The suitability of a particular paint dispersion for use in the present invention may be tested by slowly adding the acid, as an aqueous solution, dropwise to the paint dispersion. If the paint coagulates after a measured time, then it is suitable for use in the present method. The test is set forth in some detail in the Examples herein to illustrate the improvement of the present invention.

Numerous acid-coagulable water thinnable paints of use in the present invention are described in EP A 0 409 459 and in U.S. Pat. No. 5,544,972. As disclosed in EP A 0 409 459, the pH of the paint formulations is adjusted to a range of from 8 to 10 by using known bases, such as sodium hydroxide solution, ammonia or a variety of organic amine bases. Upon addition of the acid, the pH moves to the acid side and the paint “cures” or coagulates.

The polycarboxylic acids of use in accordance with the present invention are those having groups that are linear, branched or cyclic alkylene up to C₁₀, C₆-C₁₄ arylene or C₅-C₁₃ heteroarylene with nitrogen or sulfur as the heteroatom or mixed linear, branched or cyclic alkylene up to C₁₀, C₆-C₁₄ arylene or C₅-C₁₃ heteroarylene. These compounds are illustrated by oxalic acid, malonic acid, malic acid, fumaric acid, 3-methyl-1,4-butanedicarboxylic acid, 1,4-cyclohexanedicarboxylic acid, phthalic acid, isophthalic acid, 1,2-benzenediacetic acid, 2,3-furanedicarboxylic acid, ethylenediamine tetraacetic acid and the like.

As a preferred group of polycarboxylic acids of use in the present invention, the materials commonly called “dibasic acids” can be used as the acid herein. Such acids are typically derived from the straight-chain paraffins by attachment of carboxylic acid groups at the two ends of the chain. These acids include oxalic acid, malonic acid, succinic acid, glutaric acid, adipic acid, pimelic acid, suberic acid, azelaic acid and sebacic acid. Preferably, malonic acid is used in the method of the present invention.

In using the polycarboxylic acids as disclosed herein, it is preferred that they be applied to the water thinnable, acid coagulable paint in an aqueous solution. Most preferably the concentration of such acids in the solution is from about 5% by weight to about 30% by weight. Particularly preferred is an aqueous solution of the polycarboxylic acids from about 10% by weight o about 20% by weight.

In the method of the present invention when the polycarboxylic acid is used as a coating on particulate material to cure the water thinnable, acid coagulable paint, a 5% by weight to 30% by weight aqueous solution of the acid is admixed with the particulate material. After agitating the resulting slurry to assure a uniform dispersion of polycarboxylic acid, the coated particulate matter is filtered, dried for a suitable time and the dried, coated particles are mixed with the water thinnable, acid coagulable paint to achieve a cured paint coating.

The preferred particulate material for use in the present invention is glass beads. By using these beads, not only is the cure of the paint formulation assured but a reflective pavement marking occurs.

The present invention is described in detail in the examples given below which are provided by way of illustration only and therefore should not be construed as limiting the scope of the present invention.

### EXAMPLES

### Testing Procedure

In the following examples, the composition of the water thinnable, acid coagulable paint was as follows:

| Ingredient | Percent |
|---|---|
| C.I. Pigment, Yellow 65 | 2.5 |
| Rutile Titanium Dioxide | 1.6 |
| Calcium Carbonate, Type PC | 11.70 |
| Calcium Carbonate, Type GC | 36.20 |
| Hydroxy Ethyl Cellulose | 0.05 |
| Acrylic Emulsion, 50% solids | 41.70 |
| Texanol | 1.80 |
| Defoamer | 0.48 |
| Dispersant | 0.70 |
| Surfactant | 0.15 |
| Methyl Alcohol | 2.20 |
| Preservative | 0.12 |
| Water | 0.80 |

Acid Solution Preparation

The following commercially available acids were employed for preparing the acid test solutions: Malonic Acid, 99%, Citric Acid, 99.5% and Acetic Acid, 56%.

For the preparation of Malonic Acid and Citric Acid test solutions, 16 grams of each of the acids was dissolved in 30 grams of methyl alcohol to form a 35% acid test solution.

For the acetic acid test solution, 56% acetic acid was diluted with 102 grams of methyl alcohol to form a 35% acid test solution.

Bead Coating Procedure

454 grams of glass beads, is admixed with 23 grams of each of the 35% acid test solutions. The mixture is mixed while heating to a temperature of 120° F. until the resulting bead mixture is dry and free flowing.

Acid Cure Test Procedure

Into a 100 mL plastic beaker is weighed 30 grams of the above water thinnable paint composition. The acid-coated beads, prepared as disclosed, above were measured into a pint cup having a 3 centimeters diameter hole in the side. The cup and its contents were weighed. The cup was next placed on a vibrating plate set at a frequency of x and tilted at an angle of y. As the plate vibrated, the beads flowed at a constant rate of about 4 to 5 grams per minute from the hole in the side of the pint cup and onto a plastic trough that was angled at 45°. The beads continued down the trough dropping into the plastic beaker containing the water thinnable paint. As the beads dropped from the trough, they were constantly mixed into the water thinnable paint by means of a glass mixing tool. The addition of the beads into the water thinnable paint was stopped when the paint was cured by becoming gelled and\or powdery. The pint cup containing the remaining beads was again weighed and the weight loss calculated. This weight loss value was recorded as the amount of acid coated beads required to cure the water thinnable paint.

Effectiveness of Acids for Curing Water Thinnable Paint

The results of the above illustrative test are shown below:

| | | Amount (grams) required to |
|---|---|---|
| | Acid | cure the water thinnable paint |
| 1 | Malonic Acid | 11.6 |
| 2 | Citric Acid | 14.5 |
| 3 | Acetic Acid | >100 |

1. In a method of applying horizontal markings to roads or other traffic areas comprising applying to the road or other traffic area an aqueous, water-thinnable, acid-coagulable emulsion paint and contacting the applied paint with an acid, the improvement comprising using as the acid one or more polycarboxylic acid selected from the group consisting of a dicarboxylic acid, a tetracarboxylic acid or mixtures thereof.

2. The improvement according to claim 1 wherein said polycarboxylic acid is a dicarboxylic acid

3. The improvement according to claim 2 wherein said dicarboxylic acid is a dibasic acid

4. The improvement according to claim 3 wherein said dibasic acid is selected from the group oxalic acid, malonic acid, succinic acid, glutaric acid and adipic acid.

5. The improvement according to claim 4 wherein said dibasic acid is malonic acid.

6. The improvement according to claim 1 wherein the polycarboxylic acid is sprayed onto the applied paint.

7. The improvement according to claim 1 wherein the polycarboxylic acid is first coated onto glass beads and then said coated glass beads contact said applied paint.
